(19) United States
(12) Patent Application Publication
(10) Pub. No.: US 2006/0230010 A1
(43) Pub. Date: Oct. 12, 2006

(54) System and method for implementing decision systems

(75) Inventors: Kareem Sherif Aggour, Schenectady, NY (US); Marc Pavese, Richmond, VA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/093,312

(22) Filed: Mar. 29, 2005

(51) Int. Cl. G06F 15/18

(52) U.S. Cl. 706/62

(57) ABSTRACT

A method for implementing and operating a decision system is provided. The method comprises collecting one or more input cases. Each input case defines a relationship in a decision space upon which the decision system is designed to operate. The method then comprises providing a configuration file accessible by a coordinating software module. The configuration file defines the transformation of data in the input cases into a format suitable for use by different software components that interact in the decision system. The configuration file can be modified to invoke different software components without re-writing the software components or altering the input cases. The method further comprises passing the one or more input cases to the coordinating software module. The method finally comprises translating the data in the one or more input cases in accordance with the transformation defined in the configuration file and passing the translated data to the decision system for processing a decision.

### BACKGROUND OF THE INVENTION

The invention relates generally to decision systems and more particularly to a system and method that defines a framework for connecting and integrating the components that comprise a decision system, in a generic manner.

Several decision-making techniques are known in the art, and may be employed for the purpose of decision-making in decision systems. Some of these techniques include, but are not limited to, rule-based reasoning, neural network, fuzzy logic, case-based reasoning, and other soft computing, machine learning, and/or artificial intelligence techniques. The performance of a decision system may, in general, depend on several factors, such as, the particular format in which input data delivered to the decision system is processed to execute a particular decision algorithm, and the regular maintenance and timely update of data in the knowledge base that comprises a decision system.

Decision systems are generally implemented using programming tools such as Java, C, C++ or using tools customized for mathematical and statistical programming, such as Matlab or Statistical Analysis Systems. A challenge faced by existing tools for decision-making is the quick testing and comparison of the results of multiple decision techniques or decision algorithms for solving a single problem. In addition, the tools that implement these multiple techniques for decision-making sometimes require input data in different formats and may produce the output data in more than one format. Furthermore, the use of the above tools in the decision-making process may require that each functional component comprising the decision system be redeveloped each time a decision system is implemented, since these tools, in general, do not have the special functionality related to the major functional components of the decision system. For example, components for accessing the inputs to the decision system and components for storing their outputs are traditionally designed and implemented separately for each decision system, though the actual functionality may be nearly identical.

Another challenge faced in the implementation of decision systems, in general, is the quick transition from a prototype stage of implementation to the final production system with minimal rework. As is known to those skilled in the art, the modeling software, the input data formatting and the pre-processing that takes place within a decision system may vary between the prototype and the actual production system. Therefore, when the transition from the prototype system to the production decision system occurs, the above issues may have to be resolved again using different tools appropriate to the new environment, resulting in extensive rework and significant risk.

Therefore, there is a need for a system and method that defines a framework to facilitate the implementation, optimization and production use of a decision system by enabling the quick specification and integration of generic components within the decision system in an efficient manner.

### BRIEF DESCRIPTION

Embodiments of the present invention address this and other needs. In one embodiment, a method for operating a decision system is provided. The method comprises collecting one or more input cases. Each input case defines a relationship in the decision space upon which the decision system is designed to operate. The method then comprises providing a configuration file accessible by a coordinating software module. The configuration file defines the transformation of data in the input cases into a format suitable for use by different software components that interact in the decision system. The configuration file can be modified to invoke different software components without re-writing the software components or altering the input cases. The method further comprises passing the one or more input cases to the coordinating software module. The method finally comprises translating the data in the one or more input cases in accordance with the transformation defined in the configuration file and passing the translated data to the decision system for processing a decision.

In another embodiment, a decision system is provided. The decision system comprises one or more input cases. Each input case defines a relationship in the decision space upon which the decision system is designed to operate. The system further comprises a coordinating software module configured to transform data in the input cases into a format suitable for use by different software components that interact in the decision system, using a configuration file. The configuration file can be modified to invoke different software components without re-writing the software components or altering the input cases. The system further comprises a decision engine component configured to use the transformed data from the coordinating software module for processing a result associated with the decision system.

### DRAWINGS

These and other features, aspects, and advantages of the present invention will become better understood when the following detailed description is read with reference to the accompanying drawings in which like characters represent like parts throughout the drawings, wherein:

FIG. 1 is an exemplary illustration of a high-level framework for automatically implementing a decision system, in accordance with one embodiment of the present invention;

FIG. 2 is an exemplary illustration of a configuration file within the coordinating software module shown in FIG. 1; and

FIG. 3 is a flowchart illustrating an exemplary operation of the decision system shown in FIG. 1.

### DETAILED DESCRIPTION

Disclosed herein is a framework for implementing a decision system. The framework disclosed in accordance with the present invention facilitates the implementation, optimization and use of a decision system by enabling the quick specification and integration of generic components that comprise a decision system. In addition, embodiments disclosed in the present invention offer several advantages including the ability to easily incorporate additional functionality, such as data input, data output, data processing and data optimization into the decision system without the need to re-write the software components of the decision system each time a decision system is implemented. Embodiments of the present invention address the above aspects by integrating the components of a decision system using configuration files to tie together a set of software components that comprise the decision system in a generic manner, wherein each software component performs a major functional step in the operation of the decision system. In a particular embodiment of the present invention, and as will be described in greater detail below, the disclosed framework is an object-oriented framework, and is represented by a system and method for integrating the generic components of a decision system.

As is known to those skilled in the art, a “software framework” is a term generally used in object-oriented software design and refers to a collection of interrelated classes that may be reused as a whole or in parts. Additionally, frameworks may use abstract classes at key points in the implementation of decision systems, to provide areas of customization that programmers can use to create diverse applications. These areas of customization are sometimes referred to as “hot spots” in a software framework.

The framework defined by the system and method in accordance with one embodiment of the present invention, integrates the generic aspects of decision systems by providing “hot spots” for the various functions (or alternatively, the various software components) within the decision system. Further, and as will be described in greater detail below, the user, in accordance with the present invention, determines the particular software components that need to be plugged into each of the “hot spots” and defines the manner in which each component is configured via a set of configuration files, thereby enabling the implementation of a decision system without requiring programming.

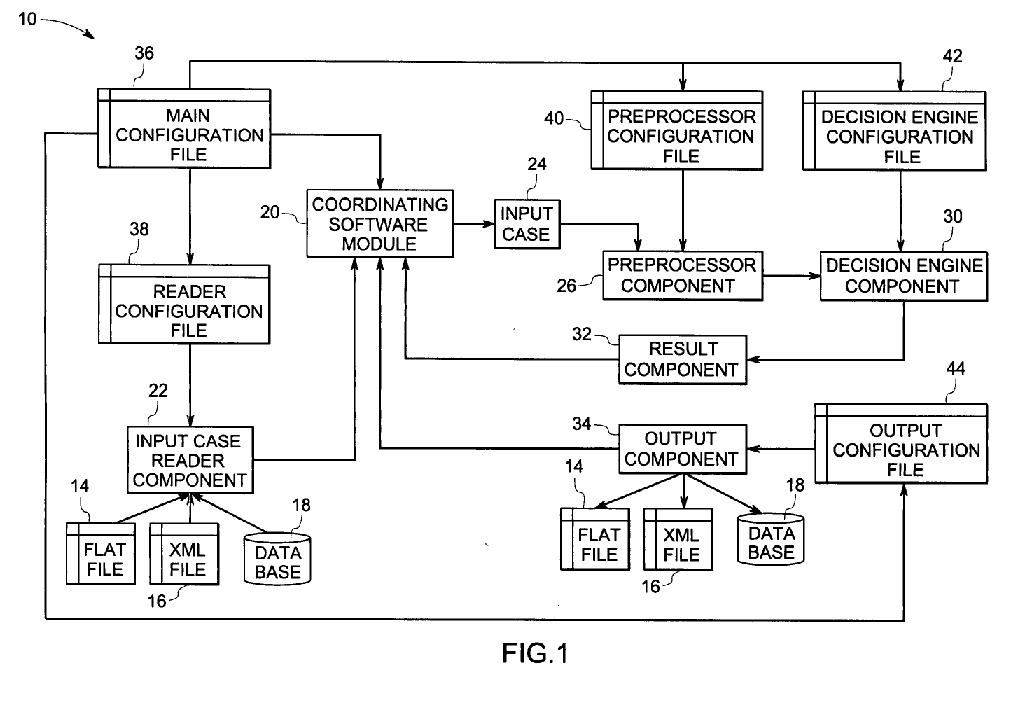

FIG. 1 is an exemplary illustration of a high-level framework for automatically implementing a decision system, in accordance with one embodiment of the present invention. As shown in FIG. 1, the decision system 10 generally comprises a coordinating software module 20, one or more input cases 24, and a decision engine component 30. Also, as shown in FIG. 1, the decision system 10 may further comprise an input case reader component 22, a preprocessor component 26, a result component 32 and an output component 34.

The input cases 24 define a relationship in the decision space upon which the decision system is designed to operate. As is known to those skilled in the art, the term “decision space” generally refers to a relationship between an input condition and an output condition in the decision system and is defined by the set of all possible outcomes for a given problem. The set of possible outcomes are defined by the alternatives or the variables that are the potential solutions to the problem and the criteria or constraints that measure or limit the solution. In one embodiment, the input cases 24 are read from one or more data sources by the input case reader component. Further, in accordance with this embodiment, the data sources may include flat files 14, XML files 16 or a database 18.

In accordance with a particular embodiment of the present invention, the coordinating software module 20 is implemented as a concrete class that ties together the above components in order to perform the decision-making for the decision system 10, via the configuration files. As is known to those skilled in the art, a “concrete class” is a term used in object-oriented programming that refers to a class that can be directly instantiated. The input case reader component 22 is implemented as an interface that defines the structure of one or more input case reader classes, the preprocessor component 26 is implemented as an interface that defines one or more input case preprocessing classes, the decision engine component 30 is implemented as an interface that defines the structure of one or more decision engines within the decision engine component 30, the result component 32 is implemented as an interface that defines the structure of a generic and extensible result class and the output component 34 is implemented as an interface that defines the structure of one or more output result handling classes.

The coordinating software module 20 drives the entire decision system 10 and may be configured to execute any of the components in the decision system 10. In a particular embodiment, and as will be described in greater detail below, the coordinating software module 20 instantiates and initializes the decision engine component 30, provides it with one or more input cases 24 from the input case reader component 22 and finally hands the results to the output component 34. In particular, the coordinating software module 20 transforms the input cases into a format suitable for use by the different software components that interact within the decision system 10, using one or more configuration files in a manner as will be described in greater detail below. Furthermore, all the above components are functionally independent and are fully configurable through the configuration files as will be described below.

Referring to FIG. 1 now, a main configuration file 36 accessible by the coordinating software module 20 references several other configuration files, such as, for example, 38, 40, 42 and 44, as shown in FIG. 1. Each configuration file configures a particular component or alternatively, a particular “hot spot” within the decision system 10. In a particular embodiment, the “hot spots” that are configured may include the input case reader component 22, the preprocessor component 26, the decision engine component 30 and the output component 34.

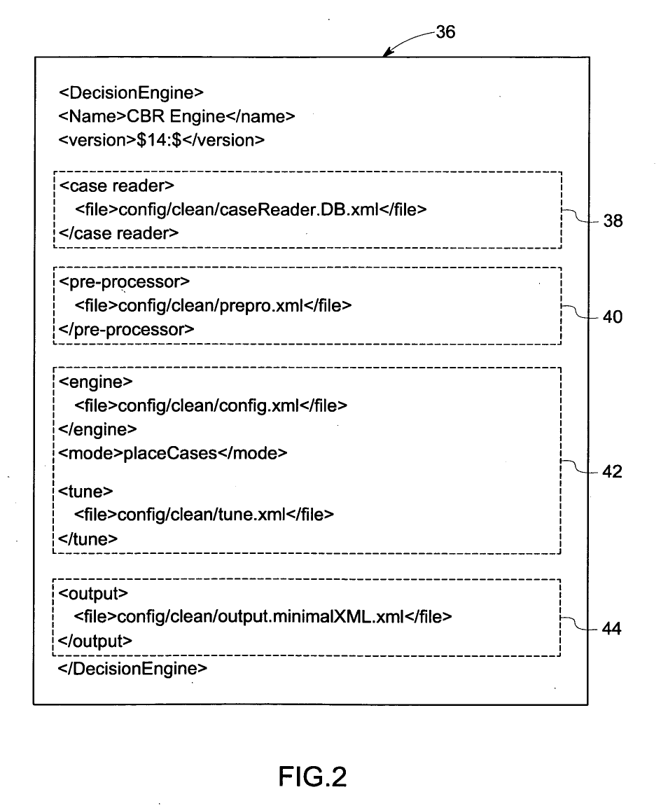

In one embodiment of the present invention, each of the configuration files, 38, 40, 42 and 44 may be implemented as separate files that are individually accessible by the various components that comprise the decision system 10. FIG. 2 is an exemplary illustration of this embodiment, in which each configuration file is referenced from the main configuration file 36. In an alternate implementation, the content from one or more configuration files can be embedded within the main configuration file 36, instead of referencing a separate file. Referring to FIG. 2, the main configuration file is indicated by the reference numeral 36 and references several other configuration files within it, such as, for example, 38, 40, 42 and 44. In this implementation, the configuration files may be individually accessible by the various components via the main configuration file 36.

The information in the configuration files defines the transformation of data in the input cases into a format suitable for use by the different software components that interact within the decision system. Furthermore, the configuration files can be modified to operate on the various software components comprising the decision system 10 without re-writing the components or altering the input cases. Also, as will be described in greater detail below, the configuration files in accordance with the present invention specify the software components to be loaded as well as the configuration information for each component.

In accordance with an exemplary operation of the decision system 10, the coordinating software module 20 initially creates an instance of the input case reader class that comprises the input case reader component 22. The input case reader class contains methods for initializing with the reader configuration file 38, obtaining the set of input cases, and making them available to the coordinating software module 20 as input case objects. In a particular embodiment of the present invention, the reader configuration file 38 determines the location of the input cases and the access method to be used to access these input cases. The type of access method used, may comprise, for example, reading input data from a database, loading input data from an extensible Markup Language (XML) file, accessing data over the Internet via hypertext transfer protocol (http), or other means.

In certain embodiments of the present invention, the coordinating software module 20 may then pass the input case objects from the input file reader component 22 to the preprocessor component 26 if initial preprocessing of the data in the input cases is necessary. The preprocessor component is configured via the preprocessor configuration file 40. In accordance with a specific embodiment, the preprocessor configuration file 40 may contain one or more function elements, wherein each function element specifies a concrete preprocessing class in the form of a preprocessor component 26 that performs a particular type of data transformation to be performed on the input case objects. The function elements may include, for example, certain arithmetic operations to be performed on the input case. The preprocessor component 26 then executes and outputs the pre-processed input case objects to the coordinating software module 20. Concrete preprocessing classes include taking the average of a set of numbers, calculating ratios from a pair of numbers, and finding the length of a text string, among many others.

The coordinating software module 20 then passes the pre-processed input case objects from the preprocessor component 26 to the decision engine component 30 for processing a result associated with a particular type of decision engine, that is present within the decision engine component 30. The decision engine component 30 invokes the decision engine configuration file 42. The decision engine configuration file 42 includes information related to making decisions on the set of input case objects or optimizing one or more parameters of the decision engine component 30. The particular mode of operation specified in the configuration file determines the type of decision method that will be invoked by the decision engine component 30. For example, the decision engine configuration file 42 shown in FIG. 2 indicates two modes of operation, “placeCases” and “tune”. The placeCases method relates to making decisions on a set of input case objects. This method is invoked for each input case object and outputs a result object. The tune method enables the optimization of one or more parameters of decision engine component 30. This method produces an XML file as output, which is a copy of the decision engine configuration file 42 with the tunable parameters automatically optimized. Referring again to the decision engine configuration file 42, the particular mode that is invoked in this exemplary illustration is the placeCases mode, as indicated by the content in the mode XML tag <mode> placeCases </mode>.

The decision engine configuration file 42 may also comprise information related to executing the particular type of decision engine within the decision engine component 30. In accordance with the present embodiment, the decision engines that may be implemented within the decision engine component 30 include, but are not limited to, a fuzzy logic rules engine, a case-based reasoning engine and a function-chaining engine. These decision engines within the decision engine component 30, form the heart of the framework within the decision system 10, and implement the analytic decision-making in the decision system. One of ordinary skill in the art will recognize that the above examples of the types of decision engines that may be implemented within the decision system component 30 is for illustrative purposes, and is not meant to limit other types of decision engines that may be implemented within the decision system component 30. Further details of decision systems can be found in co-pending U.S. Patent Application US20030187700 entitled “PROCESS FOR RULE-BASED INSURANCE UNDERWRITING SUITABLE FOR USE BY AN AUTOMATED SYSTEM”, filed on 18 Jun. 2002 and assigned to the same assignee as this application, the entirety of which is hereby incorporated by reference herein.

The coordinating software module 20 then passes the results produced by the decision engine component 30 to the output component 34. The output component 34 handles the results produced by the decision engine component 30. The output configuration file 44 comprises information related to the manner in which the results produced by the decision engine component 30 may be handled, and specifies the different types of output formats for decision results that are produced by the execution of the decision engine component 30. In particular, the output result handling classes in the output component 34 comprises methods for the initialization and handling of the results from the decision engine component 30. As shown in FIG. 1, the results produced by the decision engine component 30 may initially be stored in the result component 32. The output component 34 may also comprise methods to perform certain data analysis functions or other additional post-processing of the results stored in the result component 32. The output component 34 may further comprise methods to write the results to the flat file 14, the XML file 16 or the database 18, as shown in FIG. 1.

Further, in an exemplary implementation of the present embodiment, the configuration files described above are implemented using non-validated XML (no Document Type Definitions or schemas) so that initialization of each component can take place using arbitrary XML. In addition, in this implementation, all of the parameters required to configure each component are exposed to the user in appropriate sections of the XML file. Also, since different components may require different sets of parameters, each component is responsible for interpreting and validating its own XML content. One of ordinary skill in the art will recognize that the above example of using XML to implement the configuration files is for illustrative purposes only, and is not meant to limit other types of data definition languages that may be used to implement the configuration files and initialize the components that comprise the decision system 10.

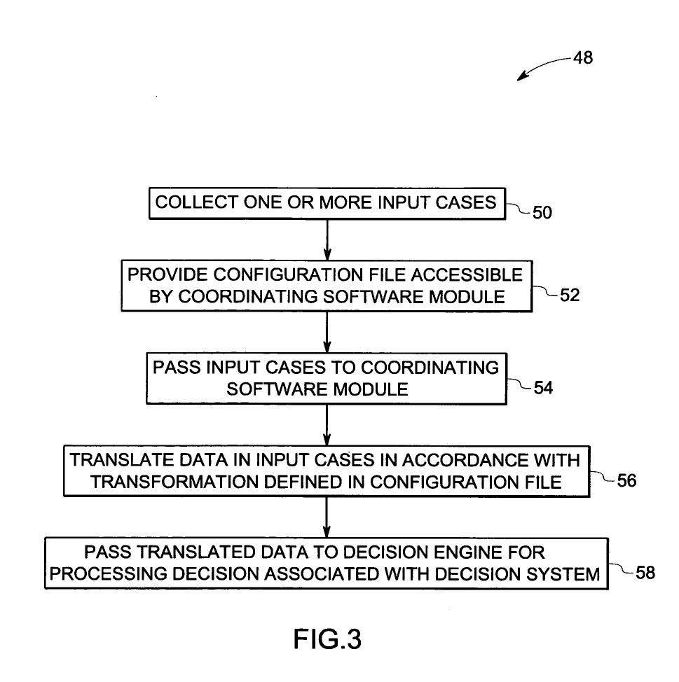

FIG. 3 is a flowchart illustrating an exemplary operation of the decision system shown in FIG. 1. The flowchart, denoted by the reference numeral 48, illustrates the method of operating a decision system in accordance with an embodiment of the present invention. The method initially comprises collecting one or more input cases in step 50. As discussed above, each input case defines a relationship in the decision space upon which the decision system is designed to operate. In one embodiment, the input cases 24 are read from one or more data sources by an input case reader. Further, in accordance with this embodiment, and as shown in FIG. 1, the data sources include flat files 14, XML files 16 and database 18.

In step 52, a configuration file accessible by a coordinating software module 20 as described above is provided, that defines the transformation of data in the input cases into a format suitable for use by different software components that interact in the decision system. As mentioned with respect to FIG. 1, the configuration file can be modified to operate on the software components that comprise the decision system without re-writing the software components or altering the input cases.

In step 54, the input cases 24 are passed to the coordinating software module 20. In particular, the reader configuration file 38, as described above, comprises information related to the location of the input cases and the type of access method to be used to access the input case.

In step 56, the input case is translated in accordance with the transformation defined in the configuration file. More specifically, and as described above, the preprocessor configuration file 40 performs the initial translation or preprocessing of the input case. As mentioned above, the preprocessing further comprises performing a data transformation of the input case into a suitable format for use by the decision system. The data used to create the input cases 24 may not be in the exact format required for the decision engine component 30 to make decisions. Preprocessor configuration file 40 defines a translation process to convert any of the input data elements into a format appropriate for making decisions. Transformations can be arbitrarily defined by a user, and can combine multiple input variables or operate on a single variable.

Finally, in step 58, the translated data is passed to a decision engine for processing a decision associated with the decision system 10. More specifically, the decision engine configuration file 42 as described above comprises information related to executing a particular type of decision engine within the decision engine component 30. The decision results may then be output in a suitable manner such as, described above. The output configuration file 44 as described above comprises information related to the manner in which to handle the results produced by the decision engine, and specifies the different types of output formats for decision results from the execution of the decision engine.

The disclosed software framework facilitates the rapid development and deployment of decision systems by providing a system and method for integrating the generic components of decision systems without writing code. The disclosed system and method eliminates much of the low-level rework required to develop decision systems, and does not require the implementation of independent methods for each of the steps of data input, output, preprocessing, optimization, as described above, or the use of a pre-packaged decision system that has to conform to the functionality that is available within the system.

In addition, the interactions between all the components that comprise the decision system, described above, may be performed via their corresponding interfaces, and the concrete classes within these components may be loaded dynamically at run time. Furthermore, all the components may be accessible without requiring any code alteration. For example, consider two components, component A and component B within the decision system 10. For component A to load component B, component A specifies the class name of component B in its configuration file. This enables the swapping in and out of different components without rewriting code. In accordance with one aspect of the present technique, if the functionality of component B had to be replaced with that of another component within the decision system, say, for example, a component B′, only a modification to A's configuration file to point to B′ instead of B would need to be performed, thereby eliminating the need to re-write the software components. For example, if input data were initially stored in flat files, an input case reader component could be developed to access those files. Later, if a database was used to store input data, a new database input case reader component could be developed. One would then need to modify only the input case reader component class reference to access this new case reader class, without having to modify any source code. Therefore, in accordance with this aspect, any class can be extended or replaced by another class implementing the same interface, and the other classes around it will not require any modification or re-compilation.

In addition, the disclosed framework comprises a library of concrete implementations for the “hot spots” that cover a large amount of the basic functionality needed to construct a working decision system. No additional programming of the components is needed unless customized extensions of the provided library of classes are required. If this is necessary, newly programmed classes can easily be integrated into the system with no alterations to any of the core software.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of operating a decision system, the method comprising:
collecting one or more input cases, wherein each input case defines a relationship in a decision space upon which the decision system is designed to operate;
providing a configuration file accessible by a coordinating software module, wherein the configuration file defines the transformation of data in the input cases into a format suitable for use by different software components that interact in the decision system, and wherein the configuration file can be modified to operate on the software components without re-writing the software components or altering the input cases;
passing the one or more input cases to the coordinating software module;
translating the data in the one or more input cases in accordance with the transformation defined in the configuration file; and
passing the translated data to a decision engine within the decision system for processing a decision.

2. The method of claim 1, wherein the input cases are read from one or more data sources by an input case reader.

3. The method of claim 2, wherein the data source comprises a database.

4. The method of claim 2, wherein the data source comprises an XML file.

5. The method of claim 2, wherein the data source comprises a flat file.

6. The method of claim 1, wherein the configuration file comprises information related to the location of the input cases and the type of access method to be used to access the input cases.

7. The method of claim 1, wherein the configuration file comprises information related to pre-processing of the data in the input cases, wherein the pre-processing comprises performing a data transformation of the data in the input cases, into a suitable format for use by the decision system.

8. The method of claim 1, wherein the configuration file comprises information related to executing a particular type of decision engine comprising the decision system.

9. The method of claim 8, wherein the decision engine comprises at least one of a fuzzy logic rules engine, a case-based reasoning engine and a function-chaining engine.

10. The method of claim 1, wherein the configuration file comprises information related to specifying different output formats for decision results that result from the execution of a decision engine comprising the decision system.

11. The method of claim 10, wherein the configuration file further comprises information related to post-processing the decision results, wherein the post-processing comprises specifying data analysis functions to be performed on the decision results.

12. A decision system comprising:
one or more input cases, wherein each input case defines a relationship in a decision space upon which the decision system is designed to operate;
a coordinating software module configured to transform data in the input cases into a format suitable for use by different software components that interact in the decision system, using a configuration file, wherein the configuration file can be modified to operate on the software components without re-writing the software components or altering the input cases; and
a decision engine component configured to use the transformed data from the coordinating software module for processing a result associated with the decision system.

13. The system of claim 12, wherein the input cases are read from one or more data sources by an input case reader component.

14. The method of claim 13, wherein the data source comprises a database.

15. The method of claim 13, wherein the data source comprises an XML file.

16. The method of claim 13, wherein the data source comprises a flat file.

17. The system of claim 12, wherein the coordinating software module is configured to translate the data in the one or more input cases in accordance with the transformation defined in the configuration file.

18. The system of claim 12, wherein the configuration file comprises information related to the location of the input cases and the type of access method to be used to access the input cases.

19. The system of claim 12, wherein the configuration file comprises information related to pre-processing the data in the input cases, wherein the pre-processing comprises performing a data transformation of the data in the input cases, into a suitable format for use by the decision system.

20. The system of claim 12, wherein the configuration file comprises information related to executing a particular type of decision engine comprising the decision engine component.

21. The system of claim 20, wherein the decision engine comprises at least one of a fuzzy logic rules engine, a case based reasoning engine and a function-chaining engine.

22. The system of claim 12, wherein the configuration file comprises information related to specifying different output formats for decision results that result from the execution of a decision engine comprising the decision engine component.

23. The system of claim 22, wherein the configuration file further comprises information related to post-processing the decision results, wherein the post-processing comprises specifying data analysis functions to be performed on the decision results.
